(19) United States
(12) Patent Application Publication
(10) Pub. No.: US 2008/0159804 A1
(43) Pub. Date: Jul. 3, 2008

(54) Cosmetic or pharmaceutical product and applicator for cosmetic or pharmaceutical powders or beads and method of use

(75) Inventor: Steven E. Brown, New Windsor, NY (US)

Correspondence Address: Charles N. J. Ruggiero;Ohlandt, Greeley, Ruggiero & Perle, L.L.P., 10th Floor, One Landmark Square, Stamford, CT, 06901-2682, US

(73) Assignee: AVON PRODUCTS, INC.

(21) Appl. No.: 11/647,816

(22) Filed: Dec. 29, 2006

(51) Int. Cl. B43K 5/02

(52) U.S. Cl. 401/41

(57) ABSTRACT

There is a cosmetic or pharmaceutical product having a container, powder or beads in the container, and the flexible substrate. The flexible substrate has a plurality of grooves therein extending along a part of or an entirety of at least one face thereof. There is also provided an applicator for the cosmetic or pharmaceutical powder or beads. There is also provided a method for applying the powder or beads to a topical surface.

### BACKGROUND OF THE INVENTION

1. Field of the invention

The present invention relates to a cosmetic or pharmaceutical product for application of a cosmetic or pharmaceutical powder or beads. The present invention further relates to an applicator useful in such product. The present invention still further relates to a method for applying a cosmetic or pharmaceutical powder or beads to a topical surface.

2. Description of the Related Art

Finely divided loose-powder cosmetics are difficult to deliver or transfer to the skin. Traditional implements such as brushes or puffs require multiple applications or large surface areas to deliver significant quantities of powder. In addition, delivering significant quantities of loose powder cosmetics using traditional applicators causes an undesirable amount spillage. Furthermore, powders of large and/or dense particle size are particularly difficult to deliver or transfer. Powders of dense or large particle size have a tendency to fall off of conventional applicators, such as sponges, brushes, and powder puffs.

It would be desirable to have an applicator for cosmetic or pharmaceutical powders or beads that permits delivery or transfer in a cosmetically effective amount without spillage. It would be further desirable to have a cosmetic powder having such applicator. It would still be further desirable to have a method for applying a powder or beads to a topical surface.

### SUMMARY OF THE INVENTION

According to the present disclosure, there is provided an applicator for cosmetic or pharmaceutical powders or beads. The applicator has a flexible substrate in the form of a unitary article with a plurality of grooves or cuts partially therein extending along a part of or an entirety of a face or surface thereof. The applicator substrate can be porous or non-porous. In addition, the applicator can optionally have a handle connected to the applicator substrate to further facilitate usage.

Further according to the present disclosure, there is provided a cosmetic or pharmaceutical product. A preferred product has a container, a cosmetic or pharmaceutical powder, and an applicator. The container has a chamber and a mouth. The container optionally has a screen between the chamber and the mouth. The container has a cosmetic or pharmaceutical powder or beads in the chamber. The applicator has a substrate having a plurality of grooves therein extending along at least one face or surface thereof.

Still further according to the present disclosure, there is provided a preferred method for applying a cosmetic or pharmaceutical powder or beads to a topical surface. The method has the following steps: a) providing a flexible substrate having a plurality of grooves therein extending along a face or surface thereof, b) flexing the substrate such that the face is spread, c) contacting the powder or beads with the face of the flexed substrate such that the powder or beads enter the plurality of grooves therein, d) unflexing, i.e., relaxing, the substrate to retain the powder or beads within the plurality of grooves therein, and e) contacting the topical surface with the face of the substrate to deliver the powder or beads.

### DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a photograph of a plan view of an embodiment of a substrate of an applicator of the present disclosure.

FIG. 2 is a photograph of a plan view of another embodiment of a substrate of an applicator of the present disclosure.

FIG. 3 is a photograph of a plan view of yet another embodiment of a substrate of an applicator of the present disclosure.

FIG. 4 is a photograph of a plan view of still yet another embodiment of a substrate of an applicator of the present disclosure.

FIG. 5 is a perspective view of an embodiment of an applicator of the present disclosure.

FIG. 6 is a cross-sectional view of the applicator of FIG. 5 taken along line 6-6.

FIG. 7 is a bottom view of the applicator of FIG. 5.

FIG. 8 is a perspective view of a container (with lid thereon) having a cosmetic or pharmaceutical powder or beads therein.

FIG. 9 is a cross-sectional view of the container of FIG. 8 with the lid removed.

FIG. 10 is a top view of the container of FIG. 8 with the lid removed.

FIG. 11 is a cross-section of the applicator of FIG. 5 inserted into the container of FIG. 8 with the lid removed as shown in FIG. 9.

FIG. 12 is a plan view of an embodiment of a substrate of an applicator the present disclosure.

FIG. 13 is a cross-section view of the substrate of FIG. 12 taken along a line 13-13.

FIG. 14 is a view of the substrate as shown in the cross-section view of FIG. 13 being subject to flexure from a force.

FIG. 15 is a view of the substrate as shown in the cross-section view of FIG. 14 inverted into the open end of a container as shown.

FIG. 16 is a view of the substrate and container shown in FIG. 15 wherein the substrate and container are inverted.

FIG. 17 is a view of the substrate as shown in the cross-section view of FIG. 16 wherein the substrate has been removed from the container and stood on end.

### DETAILED DESCRIPTION OF THE INVENTION

The applicator takes the form of a flexible substrate. The substrate has a plurality of grooves or cuts therein extending along at least one face or surface thereof. The grooves may be set out in a particular pattern or they may be random. For functional and aesthetic reasons, a particular pattern is preferred. A cross-hatch pattern or configuration is preferred in which two sets or groups of substantially parallel grooves intersect. Useful cross-hatch patterns or intersecting configurations can take the form of any polygon, such as a diamond, a square, a triangle, or a trapezoid.

The grooves preferably have an average depth of about 0.5 mm to about 5 mm. The grooves preferably have an average width of about 0.01 mm to about 3 mm. Depth is measured normal to the face or surface and width is measured directional to or along the face or surface. Alternately, the average depth can be based on a proportion of the average thickness (depth) of the substrate normal to the face or surface. For instance, average depth can extend to about 1% to about 80% and preferably about 20% to about 50% of the thickness of the substrate. In addition, the depth of a groove can vary along the length of the groove as to be generally concave or convex from end to end. For instance, the depth at the end portions of a groove may be about 5% to about 95% of the maximum depth of groove. Preferably, the depth at the end portions of a groove is about 20% of the maximum depth of the groove. Averages are mean averages.

When viewed in cross-section along the length of the groove, the configuration or shape of the groove can take any shape, such as semicircular, U-shaped, square-shaped, or rectangle-shaped and can stay the same or vary along the length. The width of the groove can also be the same or vary along the depth thereof. When the width varies, the width of the top or face (opening) may be greater than, equal to, or less than the width of the base or bottom of the groove. When the width of the base and the width of the top of the groove differ, such difference will typically range from about 10 to about 80% based upon the width of the wider of the base or top. In a preferred embodiment, the width is the same or substantially the same along both the depth and length of the groove. Depending on the shape of the groove, the groove will be bounded by one or more walls. For instance, a semicircular or U-shaped groove is bounded by a single wall, whereas a square or rectangular-shaped wall may be bounded by two opposing side walls and a bridging bottom wall. Side walls may be parallel or non-parallel. Any wall may planar or curvilinear in shape.

The applicator has a substrate that is flexible and soft to the touch. The substrate can be porous or non-porous. Such substrates can be synthetic or natural in origin. Synthetic polymeric substrates can be silicone or hydrocarbon-based films or foams. Synthetic and natural sponges are useful. Synthetic foams are preferred substrates. Cross-linked foams are preferred due to their softness. Open-cell or closed-cell foams may be used. Closed-cell foams are preferred. Closed-cell, cross-linked synthetic foams are particularly preferred. A most preferred substrate is closed-cell, cross-linked polyurethane foam. Another useful substrate is a silicone elastomer foam.

In one embodiment, the grooved flexible substrate of the applicator affords enhanced delivery and transfer of powders or beads to a topical surface, such as skin and scalp. When the grooved applicator is deployed, it is pressed (with a finger or fingers or an attached/connected handle or implement) behind the grooved face or surface (in an area of the substrate generally behind the grooved face or surface) and contacted with the powder or beads. The pressure flexes the substrate and opens and/or spreads the grooved face or surface such that the grooves are rendered more open and receptive to receiving powder or beads when the substrate is contacted with the powder or beads. It may also be possible to flex the substrate and open or spread the grooves by applying inward pressure at opposing sides of the substrate, i.e., toward the center of substrate, with two opposing fingers. When pressure is released from the substrate, i.e., when the pressure on the substrate is relaxed, the substrate and the grooves return to their original, i.e., normal or resting configuration via memory effect. As grooves return to normal configuration, powder or beads becomes entrapped therein and are retained. Thus, the ability of the grooved substrate of the applicator to receive and retain powder or beads is enhanced compared to conventional flexible applicators that are not grooved. The powder or beads are delivered or transferred from the grooved substrate to a topical surface (such as skin) via direct contact between the flexible substrate and the skin. Upon contact with the topical surface, re-flexing of the substrate such as by pressure behind the grooved face or surface of the substrate (finger(s) or handle/implement) re-opens grooves and effects substantial release of entrapped powder or beads at the topical surface. Mere contact between the substrate and the topical surface may also effect release of entrapped powder or beads.

The grooves can be formed within or imparted to the flexible substrate of the applicator by any means or way known in the art. For instance, grooves can be formed by foaming of the flexible substrate within a cavity mold having protruding ribs therein. Alternately, and most preferably, a pre-formed substrate is contacted with a cutting or slicing device to impart grooves therein.

The applicator is useful for transferring or delivering cosmetic or pharmaceutical powders or beads of any conventional particle size but is particularly useful with powders or beads of large and/or dense particle size, which are particularly difficult to deliver or transfer. Large particle sizes are those exhibiting an average particle size (number average particle size) of about 0.5 to about 1000 microns and more particularly about 10 to about 100 microns. The substrate is also useful for transferring or delivering any type of cosmetic powders, including loose powders and pressed powders. Pressed powders are powders wherein sufficient compressive pressure has been applied to form a non-free flowing structure known as a cake. Cosmetic beads are typically large spherical particulate structures comprised of materials known in the art and having a particle size from about 0.5 mm to about 2 mm. Beads are typically formed via emulsion and/or suspension polymerization but any known method is suitable. Useful beads include those of olefin and styrenic polymers and copolymers, such as polyethylene, polystyrene, polypropylene, polymethylmethacrylate, styrene/acrylate copolymer, and the like. The preferred applicator has particular utility with respect to loose powders and beads, as these are particular difficult to deliver or transfer with conventional applicators.

The flexible substrate of the applicator is useful with any cosmetic or pharmaceutical powder or bead. Cosmetic compositions can be pigmented or non-pigmented. Pigmented cosmetics can include blushes, foundations, eye shadows, and lip compositions. Non-pigmented compositions can include skin care, hair care, and other types of personal care compositions. The powder or beads can have any known cosmetic or pharmaceutical agent absorbed or adsorbed therein, such as the following: anesthetics, anti-allergenics, antifungals, antimicrobials, anti-inflammatory agents, antioxidants, antiseptics, chelating agents, colorants, depigmenting agents, emollients, emulsifiers, exfollients, film formers, fragrances, humectants, insect repellents, lubricants, moisturizers, photostabilizing agents, preservatives, skin protectants, skin penetration enhancers, sunscreens, stabilizers, surfactants, thickeners, viscosity modifiers, vitamins, or any combinations thereof.

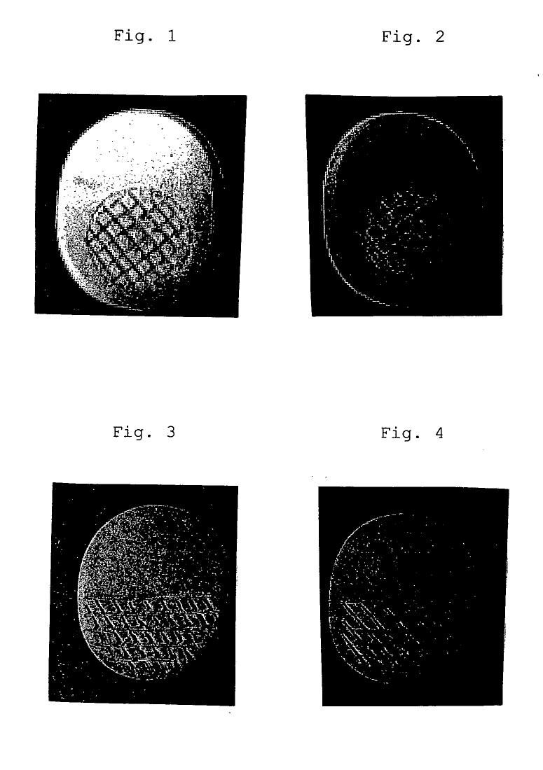

FIGS. 1 to 4 show different embodiments of the applicator of the present disclosure. FIGS. 1 to 4 represent four embodiments of flexible substrates. The substrates each have a plurality of intersecting grooves therein extending along a face thereof. The grooves are set out in a cross-hatch configuration or pattern.

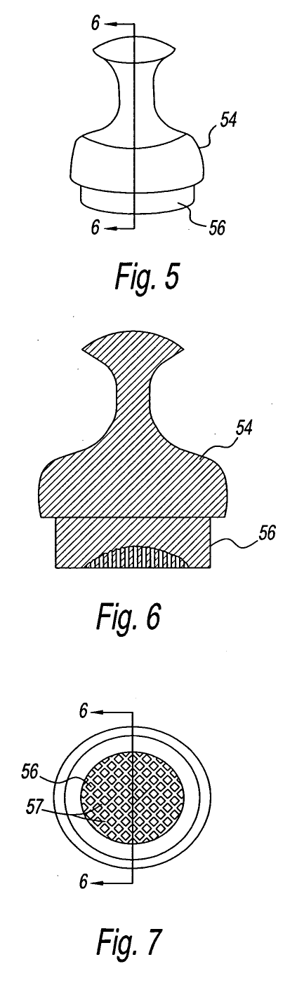

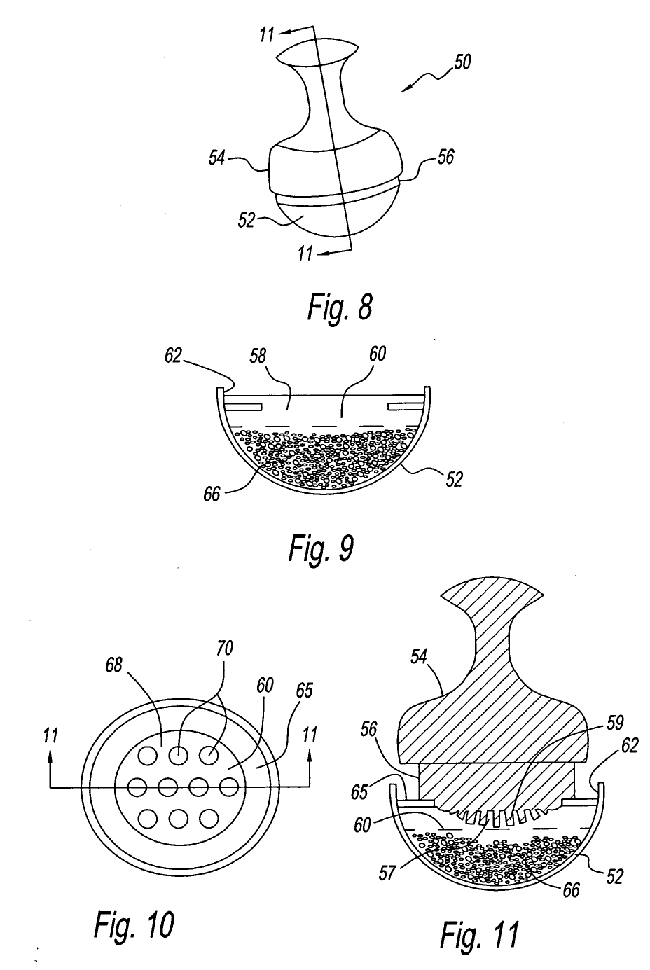

Another aspect of the present disclosure is a cosmetic or pharmaceutical product, an embodiment of which is shown in FIG. 8 and components of which are shown in FIGS. 5 to 7 and 9 to 11. The cosmetic or pharmaceutical product is generally referenced by the numeral 50 in FIG. 8. Cosmetic or pharmaceutical product 50 has a container 52 and an applicator 54. Applicator 54 has a substrate 56. Substrate 56 has a plurality of grooves 57 therein, which expose a plurality of tines 59 therebetween. Container 52 has a chamber 58, an optional screen 60, a mouth 62, a concentric ring 65 (deformation ring), and a lid (not shown). Screen 60 is positioned inside chamber 58. Chamber 58 has a cosmetic powder or beads 66 therein. Screen 60 prevents large amounts of loose powder or beads (cosmetic powder or beads 66) from freely exiting mouth 62 and controls the amount of loose powder or beads that contact with substrate 56. Screen 60 has a surface 68 and a plurality of orifices 70 therethrough. Surface 60 provides surface area upon which limited or metered amounts of loose powder or beads might reside and be accessible to substrate 56. When substrate 56 is inserted into chamber 58, the periphery of substrate 56 is contacted with concentric ring 65, which forces apart tines 59 and widens the exposed surface area of grooves 57. The widened exposure area of grooves 57 enhances the ability of substrate 56 to engage and pick up powder 66.

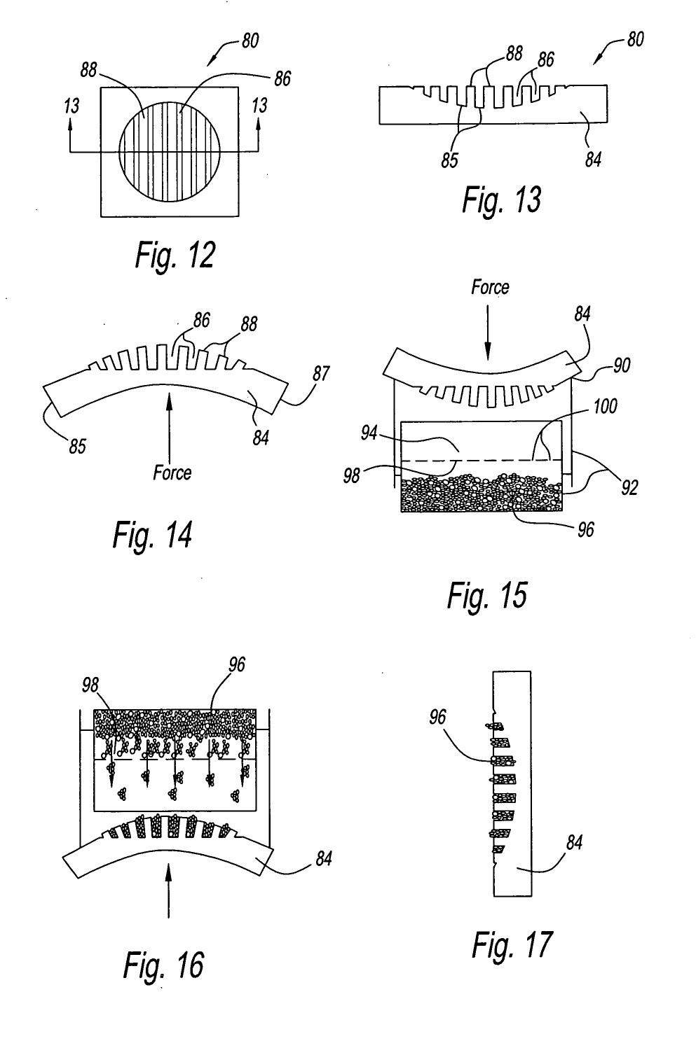

An embodiment of an applicator and use thereof of the present disclosure is shown in FIGS. 12 to 17. The applicator is generally referenced by the numeral 80 in FIG. 12. Applicator 80 takes the form of a substrate 84. Substrate 84 has a plurality of parallel grooves 86 therein, which expose a plurality of parallel tines 88 therebetween. Grooves 86 define a plurality of bottom surfaces 85, which preferably take a concave shape from end-to-end along substrate 84. The effect of force on the backside or underside of substrate 84 is shown in FIG. 14. Substrate 84 is flexed outward such that bottom surfaces 85 are contorted to become substantially curvilinear in curvature rather than concave in curvature. Grooves 86 are opened to a greater degree after flexing of substrate 84 than prior to flexing. As an alternative to imposition of a force on the backside or underside of substrate 84 to attain flexure, substrate 84 may be flexed by applying inward pressure, i.e., toward the center of substrate 84, at sides 85 and 87 with two opposing human fingers (not shown). The grooved surface or face of substrate 84 is inserted into a mouth 90 of a container 92. Container 92 has a chamber 94 therein. Chamber 94 has a cosmetic powder or beads 96 therein. A screen 98 is positioned inside chamber 94. Screen 98 has orifices 100 therethrough and prevents large amounts of loose powder 96 from freely exiting mouth 90 and controls the amount of powder 96 that can contact with substrate 84. When container 90 is inverted, powder 96 exits chamber 94 via orifices 100 and lodges into the plurality of grooves 86 of substrate 84. After substrate 84 is removed from mouth 90 of container 92 and unflexed, i.e., allowed to return to rest position, the open widths of grooves 86 narrow and powder 96 is retained therein. The ability of grooves 86 to retain powder 96 is demonstrated in FIG. 17, in which substrate 84 is allowed to stand on end yet powder 96 is retained therein.

Topical surfaces include human skin, nail, hair, and lips. The skin includes all skin surfaces, such as the face, hands, arms, legs, and feet.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances that fall within the scope of the appended claims.

What is claimed is:

1. A cosmetic or pharmaceutical product, comprising
a) a container, the container having a chamber therein, the container having a cosmetic or pharmaceutical powder or beads in the chamber, and
b) a flexible substrate having a plurality of grooves therein extending along a part or an entirety of at least one face thereof, the grooves being adapted to receive, retain, and deliver the powder or beads.

2. The product of claim 1, wherein the substrate is a synthetic or natural sponge.

3. The product of claim 1, wherein the substrate is a silicone elastomer foam.

4. The product of claim 1, wherein the substrate is a closed-cell, cross-linked polyurethane foam.

5. The product of claim 1, wherein the plurality of grooves are positioned in a parallel configuration.

6. The product of claim 1, wherein the plurality of grooves are positioned in an intersecting configuration.

7. The product of claim 1, wherein the plurality of grooves are positioned in at least two parallel directions wherein the grooves form an intersecting configuration.

8. The product of claim 1, wherein the plurality of grooves are positioned in a non-parallel configuration.

9. The product of claim 1, wherein the plurality of grooves are positioned in a diamond-shaped configuration.

10. The product of claim 1, wherein the plurality of grooves are positioned in a square-shaped configuration.

11. The product of claim 1, wherein the grooves have an average depth of about 0.5 mm to about 5 mm.

12. The product of claim 1, wherein the grooves have an average width of about 0.01 mm to about 3 mm.

13. The product of claim 1, wherein the grooves have two walls, and wherein the walls are parallel.

14. The product of claim 1, wherein the grooves have two walls, and wherein the walls are non-parallel.

15. The product of claim 1, wherein the applicator further comprises a handle connected to the substrate.

16. An applicator for cosmetic or pharmaceutical powders or beads, comprising a substrate having a plurality of grooves therein extending along a part of or an entirety of at least one face.

17. A method for applying a cosmetic or pharmaceutical powder or beads to a topical surface, comprising a) providing a a flexible substrate having a plurality of grooves therein extending along a face thereof, b) flexing the substrate such that the face is spread, c) contacting the powder or beads with the face of the flexed substrate such that the powder or beads enter the plurality of grooves therein, d) unflexing the substrate to retain the powder or beads within the plurality of grooves therein, and e) contacting the topical surface with the face of the substrate to deliver the powder or beads.
